(19) United States
(12) Patent Application Publication
(10) Pub. No.: US 2011/0193796 A1
(43) Pub. Date: Aug. 11, 2011

(54) TOUCH SCREEN PANEL

(75) Inventors: Se-Il CHO, Yongin-City (KR); Chung Yi, Yongin-City (KR)

(73) Assignee: Samsung Mobile Display Co., Ltd., Yongin-City (KR)

(21) Appl. No.: 12/915,918

(22) Filed: Oct. 29, 2010

(30) Foreign Application Priority Data
Feb. 5, 2010 (KR) 10-2010-0010984

(51) Int. Cl. G06F 3/041

(52) U.S. Cl. 345/173

(57) ABSTRACT

A touch screen panel capable of preventing a driving failure due to static electricity. The touch screen panel includes a transparent substrate. First sensing cells are formed on the transparent substrate and are connected to one another along a first direction by first connection lines. Second sensing cells are formed on the transparent substrate and isolated from the first sensing cells, and are connected to one another along a second direction. Each of the first sensing cells is divided into first sub-sensing cells, and the first sub-sensing cells are connected to one another through first sub-connection lines in the interior of each of the first sensing cells.

### CROSS-REFERENCE TO RELATED APPLICATION

This application claims the benefit of Korean Patent Application No. 10-2010-0010984, filed Feb. 5, 2010, in the Korean Intellectual Property Office, the disclosure of which is incorporated herein by reference.

### BACKGROUND

1. Field

Aspects of the present invention relate to a touch screen panel, and more particularly, to a touch screen panel capable of preventing a driving failure due to static electricity.

2. Description of the Related Art

A touch screen panel is an input device allowing a user's instruction to be inputted by a user's hand or object by selecting an instruction content displayed on a screen such as an image display device. To this end, the touch screen panel is formed on a front face of the image display device to convert a contact position into an electrical signal. Here, the user's hand or object is directly in contact with the touch screen panel at the contact position. Accordingly, the instruction content selected at the contact position is inputted as an input signal to the image display device.

Since such a touch screen panel is used instead of a separate input device connected to an image display device, such as a keyboard or mouse, use of the touch screen panel has increased in a greater number of fields. Touch screen panels are divided into a resistive overlay touch screen panel, a photosensitive touch screen panel, a capacitive touch screen panel, and the like.

Among these touch screen panels, the capacitive overlay touch screen panel converts a contact position into an electrical signal by sensing a change in capacitance formed between a conductive sensing pattern and another sensing pattern adjacent to the conductive sensing pattern, a ground electrode, or the like when a user's hand or object is in contact with the touch screen panel. In order to determine an exact contact position on a contact surface, sensing patterns include first sensing cells formed along a first direction to be connected to one another, and second sensing cells formed along a second direction to be connected one another.

At this time, first connection lines connecting the first sensing cells to one another intersect with second connection lines connecting the second sensing cells to one another. Since each of the first and second connection lines have a narrower width than a pattern in each of the sensing cells, their resistance is relatively higher than that of the pattern, and the thickness interposed between the first and second connection lines is thin due to the limitation of a thin-film forming process. Therefore, intersection portions of the first and second connection lines may be easily damaged by static electricity. When damage, such as dielectric breakdown, occurs at intersections of the first and second connection lines, a driving failure of the touch screen panel is caused by the damage.

### SUMMARY

According to an aspect of the present invention, there is provided a touch screen panel capable of preventing a driving failure due to static electricity.

According to an aspect of the present invention, there is provided a touch screen panel including a transparent substrate; first sensing cells formed on the transparent substrate, the first sensing cells being connected to one another along a first direction by first connection lines; and second sensing cells formed on the transparent substrate and isolated from the first sensing cells, the second sensing cells being connected to one another along a second direction, wherein each of the first sensing cells is divided into first sub-sensing cells, and the first sub-sensing cells are connected to one another through first sub-connection lines in the interior of each of the first sensing cells.

According to another aspect of the present invention, the first and second sensing cells may be formed in a diamond pattern. The first sub-sensing cells may be equally distributed along directions of the respective sides of the diamond patterns in the interior of each of the first sensing cells.

According to another aspect of the present invention, each of the second sensing cells may be divided into second sub-sensing cells, and the second sub-sensing cells may be connected to one another through second sub-connection lines in the interior of each of the second sensing cells.

According to another aspect of the present invention, the first and second sensing cells may be positioned in different layers with an insulation layer interposed therebetween. The first sensing cells may be integrally formed with the first connection lines, and the second sensing cells may be integrally formed with the second connection lines.

According to another aspect of the present invention, the first and second sensing cells may be positioned in the same layer. The first sensing cells may be integrally formed with the first connection lines on the transparent substrate. The second sensing cells may be formed so as to be patterns separated from one another, and the second sensing cells may be connected to one another along the second direction by the separate second connection lines. The second connection lines may be connected to the second sensing cells by contact holes that pass through an insulation layer formed on the second sensing cells.

According to another aspect of the present invention, each of the first sensing cells may be divided into n2 (n is a natural number of two or more) first sub-sensing cells.

According to another aspect of the present invention, each of the second sensing cells may be divided into n² second sub-sensing cells, wherein n is a natural number of two or more, and the second sub-sensing cells may be all connected to one another through respective ones of the second sub-connection lines in the interior of each of the second sensing cells.

According to another aspect of the present invention, in a touch screen panel, first sensing cells and/or second sensing cells in the touch screen panel are respectively formed in patterns divided into first sub-sensing cells and second sub-sensing cells, thereby preventing a driving failure of the touch screen panel due to static electricity.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a plan view schematically illustrating an example of a touch screen panel.

FIG. 2 is a main part plan view of the touch screen panel illustrated in FIG. 1.

FIG. 3 is a plan view schematically illustrating another example of a touch screen panel.

FIG. 4 is a main part plan view of the touch screen panel illustrated in FIG. 3.

FIG. 5 is a main part plan view illustrating an example of sensing cells according to an embodiment of the present invention.

FIG. 6 is a main part plan view illustrating an example of sensing cells according to another embodiment of the present invention.

FIGS. 7A to 7H are plan views illustrating various embodiments in which one sensing cell is divided into a plurality of sub-sensing cells.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

As referred to herein, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween.

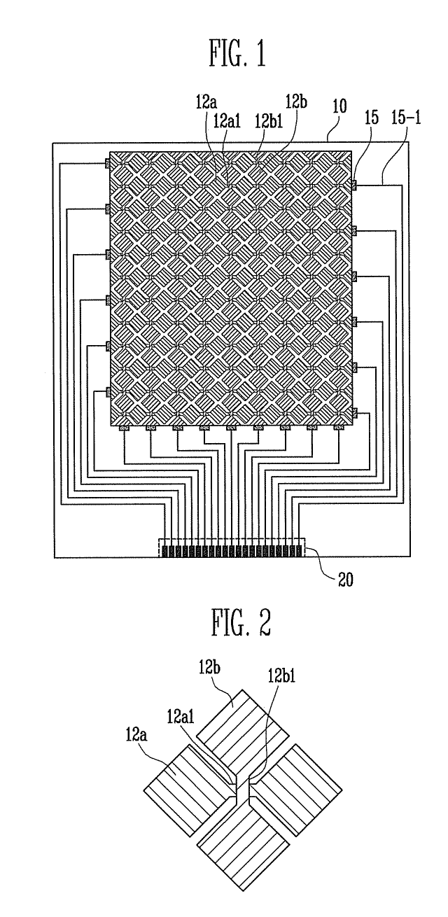

FIG. 1 is a plan view schematically illustrating an example of a touch screen panel. FIG. 2 is a main part plan view of the touch screen panel illustrated in FIG. 1. Referring to FIGS. 1 and 2, the touch screen panel includes a plurality of sensing cells 12a and 12b formed on a transparent substrate 10, and a plurality of metal patterns 15 electrically connecting the sensing cells 12a and 12b to position detecting lines 15-1.

The sensing cells 12a and 12b are formed close to one another in a regular pattern such as a diamond pattern by using a transparent electrode material such as indium tin oxide (ITO) or indium zinc oxide (IZO). However, aspects of the present invention are not limited thereto and the pattern of the sensing cells 12a and 12b is not limited to the diamond pattern or the materials noted above. That is, the sensing cells 12a and 12b may be formed in various patterns in which they are formed close to one another and may be formed of various suitable materials.

The sensing cells 12a and 12b include first sensing cells 12a connected to one another along a first direction (e.g., a horizontal direction), and second sensing cells 12b connected to one another along a second direction (e.g., vertical direction). Here, the second sensing cells 12b are alternately disposed to respectively cross over corresponding portions of the first sensing cells 12a. More specifically, the first sensing cells 12a are formed on the transparent substrate 10 and are connected to one another along the first direction by first connection lines 12a1. The second sensing cells 12b are formed on the transparent substrate 10 to be isolated from the first sensing cells 12a and are connected to one another along the second direction by second connection lines 12b1.

The first and second sensing cells 12a and 12b are positioned in different layers from each other with an insulation layer (not shown) interposed therebetween. Thus, the first sensing cells 12a are integrally formed with the first connection lines 12a1, and the second sensing cells 12b are integrally formed with the second connection lines 12b. Rows and columns of the first and second sensing cells 12a and 12b are respectively connected to the position sensing lines 15_1 by the metal patterns 15.

The metal patterns 15 are connected to the first and second sensing cells 12a and 12b at edges of the region in which the first and second sensing cells 12a and 12b are positioned so as to electrically connect them to the position sensing lines 15-1. For example, the metal patterns 15 electrically connect the first sensing cells 12a arranged by the row to the respective position sensing lines 15_1, and electrically connect the second sensing cells 12b arranged by the column to the respective position sensing lines 15-1. The metal patterns 15 are formed so that the first and second sensing cells 12a and 12b do not come in contact with each other on the insulation layer (not shown) interposed therebetween.

The position detecting lines 15-1 are connected to the respective first and second sensing cells 12a and 12b so that the first and second sensing cells 12a and 12b are connected to a driver circuit (not shown). For example, when the touch screen panel is connected to an external driver circuit through a pad portion 20, the position sensing lines 15-1 are connected between the pad portion 20 and the sensing cells 12a and 12b.

Meanwhile, according to the embodiment of FIG. 1, the metal patterns 15 and the position sensing lines 15-1 are separate components from each other. However, aspects of the present invention are not limited thereto. For example, the metal patterns 15 and the position sensing lines 15_1 may be integrally formed of the same material in the same processing operation.

The aforementioned touch screen panel is a capacitive touch screen panel. If a contact object such as a user's hand or touch stick, or other input devices and objects, comes in contact with the touch screen, a change in capacitance corresponding to a contact position is provided by the sensing cells 12a and 12b to the driver circuit via the position sensing lines 15-1 and the pad portion 20. The change in capacitance is converted into an electrical signal by X and Y input processing circuits (not shown) and the like, so that the contact position is detected.

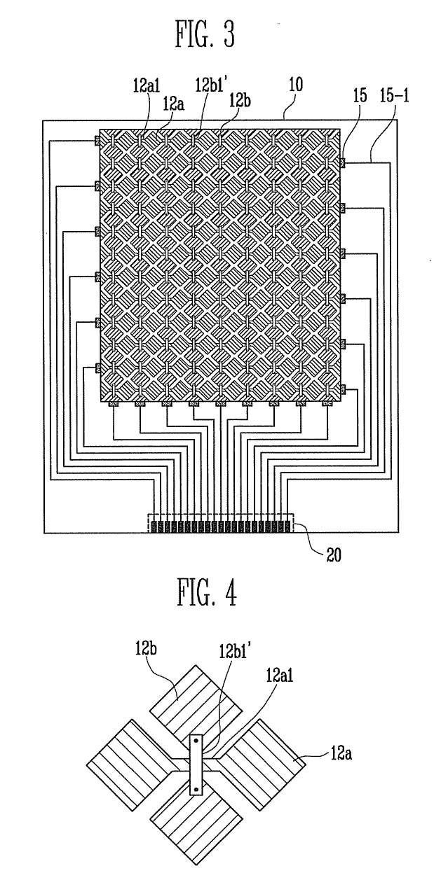

The touch screen panel in which the first and second sensing cells 12a and 12b are positioned in different layers from each other has been shown in FIGS. 1 and 2. However, aspects of the present invention are not limited thereto, and the first and second sensing cells 12a and 12b may be positioned in the same layer, as shown in FIGS. 3 and 4.

Referring to FIGS. 3 and 4, the first and second sensing cells 12a and 12b are positioned on the same layer. The first sensing cells 12a are integrally formed with the first connection lines 12a1 on the transparent substrate 10, and the second sensing cells 12a are formed in separated patterns from one another between the first sensing cells 12a formed on the transparent substrate 10. The second sensing cells 12b are connected to one another along the second direction by separate second connection lines 12b1′ formed in a different layer from the second sensing cells 12b. The second connection lines 12b1′ are formed in an insulation layer (not shown) positioned on the second sensing cells 12b, so as to be connected to the second sensing cells 12b by contact holes that pass through the insulation layer.

However, in the touch screen panels shown in FIGS. 1 to 4, each of the first connection lines 12a1 and the second connection lines 12b1 or 12b1′ has a narrower width than a pattern in each of the sensing cells 12a and 12b, and therefore, their resistance is relatively higher than that of the pattern. The thickness of the insulation layer interposed between the first connection lines and the second connection lines 12b1 or 12b1′ is thin due to the limitation of a thin-film forming process, and therefore, damage caused by static electricity easily occurs at intersection portions of the first connection lines 12b1 and the second connection lines 12b1 or 12b1′.

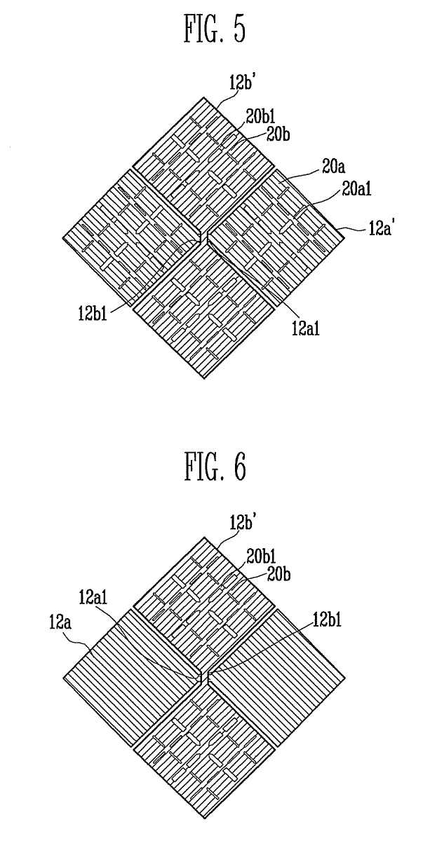

Particularly, when the sensing cells 12a and 12b serve as antennas, static electricity easily flows into the touch screen panel. Since the intersection portions of the first connection lines 12b1 and the second connection lines 12b1 or 12b1′ have a structure susceptible to the static electricity, patterns at the intersection portions are broken by the static electricity flowing from the exterior of the touch screen panel, and therefore, a driving failure of the touch screen may be caused. Accordingly, the pattern structure of the sensing cells 12a and 12b with a structure withstanding static electricity will be disclosed in the present invention, and its detailed description will be described later with reference to FIGS. 5 to 7H.

FIG. 5 is a main part plan view illustrating an example of sensing cells according to an embodiment of the present invention. FIG. 6 is a main part plan view illustrating an example of sensing cells according to another embodiment of the present invention.

Referring to FIG. 5, each of the first sensing cells 12a′ is divided into first sub-sensing cells 20a. The first sub-sensing cells 20a divide the interior of each of the first sensing cells 12a′ and are all connected to one another through one or more first sub-connection lines 20a1. Each second sensing cells 12b′ are also correspondingly divided into second sub-sensing cells 20b. The second sub-sensing cells 20b divide the interior of each of the second sensing cells 12b′ and are all connected to one another through one or more second sub-connection lines 20b1.

For example, when the sensing cells 12a′ and 12b′ are formed close to each other in a diamond pattern, the first sub-sensing cells 20a are formed in a plurality of small diamond patterns dividing the interior of the diamond pattern of each of the first sensing cells 12a′. The sub-sensing cells 20a are connected to one another through the pluralityy of first sub-connection lines 20a1. Similarly, the second sub-sensing cells 20b are formed in a plurality of small diamond patterns dividing the interior of the diamond pattern of each of the second sensing cells 12b′. The sub-sensing cells 20b are connected to one another through the plurality of second sub-connection lines 20b1.

As such, if the first and second sensing cells 12a′ and 12b′ are respectively formed in patterns each divided by the first and second sub-sensing cells 20a and 20b, the sizes of the sensing cells 12a′ and 12b′ that serve as antennas are decreased, and thus, the inflow of static electricity can be reduced. When each of the sensing cells 12a′ and 12b′ are formed in a pattern divided into sub-sensing cells 20a and 20b, respectively, as described above, concentrations of static electricity at the intersection portions of the first and second connection lines 12a1 and 12b1 are avoidable because the static electricity is distributed. Although a portion of the region having the sub-connection lines 20a1 and 20b1 is damaged by the static electricity, such damage does not affect the driving of the touch screen panel.

Accordingly, the damage due to the static electricity at intersection portions of the first and second connection lines 12a1 and 12b1 is preventable, thereby preventing a driving failure of the touch screen panel. Meanwhile, a width and a length of each of the sub-connection lines 20a1 and 20b1 that connect the sub-sensing cells 20a and 20b to one another may be experimentally determined to have a structure withstanding static electricity.

That is, the touch screen panel is variously designed to have a structure withstanding static electricity by adjusting a number of sub-sensing cells 20a and 20b dividing the interiors of the respective sensing cells 12a and 12b. Additionally, the width and length of each of the sub-connection lines 20a1 and 20b1 that connect the sub-sensing cells 20a and 20b to one another are variously adjusted to withstand static electricity.

For example, the width of the sub-connection lines 20a1 and 20b1 is designed to be different from the width of the first and second connection lines 12a1 and 12b1. Additionally, the widths of the sub-connection lines 20a1 and 20b1 are designed to be different from each other even in the interior of one sensing cell. However, aspects of the present invention are not limited thereto and the sub-connection lines 20a1 and 20b1 may have other suitable widths. Similarly, although gaps between the sub-sensing cells 20a and 20b are designed to be equal to each other in size in the interior of one sensing cell, aspects of the present invention are not limited thereto and the gaps may be designed to be different in size from each other.

Meanwhile, it has been described in FIG. 5 that each of the first and second sensing cells 12a′ and 12b′ are divided into the first and second sub-sensing cells 20a and 20b, respectively. However, aspects of the present invention are not necessarily limited thereto and only any one of the first and second 12a′ and 12b′ may be divided into the sub-sensing cells 20a or 20b. For example, when the first and second sensing cells 12a′ and 12b′ are positioned in different layers from each other, only the second sensing cells 12b′ may be divided into the second sub-sensing cells 20b as illustrated in FIG. 6. Alternatively, although not shown in FIG. 6, only the first sensing cells 12a′ may be divided into the first sub-sensing cells 20a.

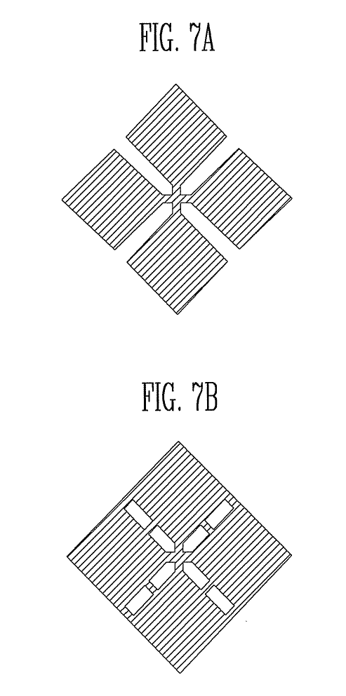

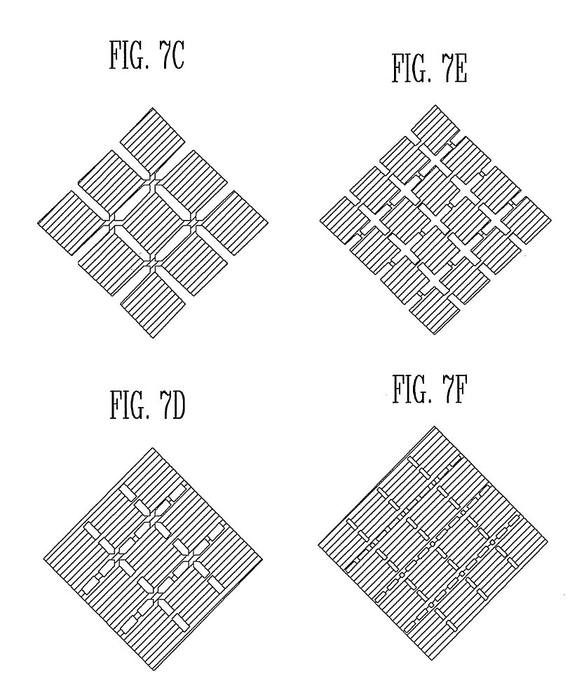

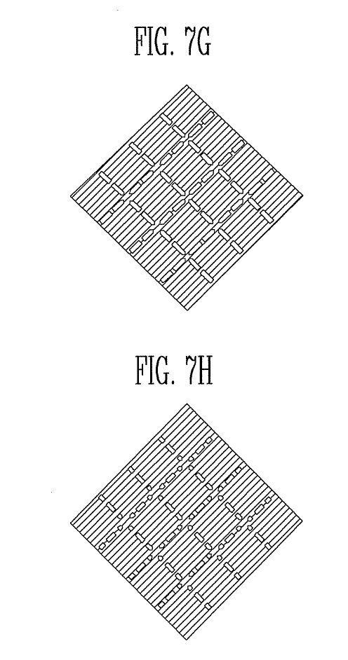

FIGS. 7A to 7H are plan views illustrating various embodiments in which one sensing cell is divided into a plurality of sub-sensing cells. For convenience of illustration, one sensing cell formed in a diamond pattern will be illustrated in FIGS. 7A to 7H. Particularly, a case where sub-sensing cells 20a are equally divided along a directions of respective sides of the diamond pattern in the interior of one sensing cell 12a will be illustrated in FIGS. 7A to 7H.

Referring to FIGS. 7A to 7H, the sub-sensing cells 20a are equally divided along the directions of the respective sides of the diamond pattern, and are all connected to one another through a plurality of sub-connection lines 20a1 in the interior of the one sensing cell 12a.

Two or more of the sub-sensing cells 20a are disposed along the directions of the respective sides of the diamond pattern, and therefore, the one sensing cell 12a is divided into n² sub-sensing cells 20a, wherein n is a natural number of two or more. For example, when n is two, the one sensing cell 12a is divided into four sub-sensing cells 20a, as illustrated in FIGS. 7A and 7B, and the number and positions of sub-connection lines 20a1 that connect the four sub-sensing cells to one another may be variously implemented.

When n is three, the one sensing cell 12a is divided in nine sub-sensing cells 20a, as illustrated in FIGS. 7C and 7d, and the number and positions of sub-connection lines 20a1 that connect the nine sub-sensing cells to one another may be variously implemented. FIGS. 7E to 7H illustrate cases where, when n is four, the one sensing cell 12a is divided into sixteen sub-sensing cells 20a. In this case, the number and positions of sub-connection lines 20a1 that connect the sixteen sub-sensing cells to one another may be variously implemented.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A touch screen panel comprising:
a transparent substrate;
first sensing cells formed on the transparent substrate, the first sensing cells being connected to one another along a first direction by first connection lines; and
second sensing cells formed on the transparent substrate and isolated from the first sensing cells, the second sensing cells being connected to one another along a second direction,
wherein each of the first sensing cells is divided into first sub-sensing cells, and the first sub-sensing cells are connected to one another through first sub-connection lines in the interior of each of the first sensing cells.

2. The touch screen panel according to claim 1, wherein the first and second sensing cells are formed in a diamond pattern.

3. The touch screen panel according to claim 2, wherein the first sub-sensing cells are equally distributed along directions of the respective sides of the diamond patterns in the interior of each of the first sensing cells.

4. The touch screen panel according to claim 1, wherein each of the second sensing cells is divided into second sub-sensing cells, and
wherein the second sub-sensing cells are connected to one another through second sub-connection lines in the interior of each of the second sensing cells.

5. The touch screen panel according to claim 1, wherein the first and second sensing cells are positioned in different layers with an insulation layer interposed therebetween.

6. The touch screen panel according to claim 5, wherein the first sensing cells are integrally formed with the first connection lines, and
wherein the second sensing cells are integrally formed with the second connection lines.

7. The touch screen panel according to claim 1, wherein the first and second sensing cells are positioned in the same layer,
wherein the first sensing cells are integrally formed with the first connection lines on the transparent substrate,
wherein the second sensing cells are formed so as to be patterns separated from one another, and
wherein the second sensing cells are connected to one another along the second direction by the separate second connection lines.

8. The touch screen panel according to claim 7, wherein the second connection lines are connected to the second sensing cells by contact holes that pass through an insulation layer formed on the second sensing cells.

9. The touch screen panel according to claim 1, wherein each of the first sensing cells is divided into n² (n is a natural number of two or more) first sub-sensing cells.

10. The touch screen panel according to claim 1, wherein each of the second sensing cells is divided into n² (n is a natural number of two or more) second sub-sensing cells, and
wherein the second sub-sensing cells are all connected to one another through respective ones of the second sub-connection lines in the interior of each of the second sensing cells.

11. The touch screen panel according to claim 4, wherein the second sub-sensing cells are equally distributed along directions of the respective sides of diamond patterns in the interior of each of the second sensing cells.

12. The touch screen panel according to claim 1, wherein a width of the first sub-connection lines is different than a width of the first connection lines.

13. The touch screen panel according to claim 4, wherein a width of second sub-connection lines is different than a width of the second connection lines.

14. The touch screen panel according to claim 4, wherein gaps are disposed between adjacent ones of the first sub-sensing cells and adjacent ones of the second sub-sensing cells, respectively.

15. The touch screen panel according to claim 14, wherein the gaps are different in size with respect to each other.

16. The touch screen panel according to claim 14, wherein the gaps are equal to each other in size.
